(19) United States
(12) Patent Application Publication
(10) Pub. No.: US 2013/0257641 A1
(43) Pub. Date: Oct. 3, 2013

(54) METHOD AND SYSTEM FOR DETECTING ANIMALS IN THREE DIMENSIONAL SPACE AND FOR INDUCING AN AVOIDANCE RESPONSE IN AN ANIMAL

(71) Applicant: Donald Ronning, Pelham, NH (US)

(72) Inventor: Donald Ronning, Pelham, NH (US)

(21) Appl. No.: 13/622,448

(22) Filed: Sep. 19, 2012

Related U.S. Application Data
(60) Provisional application No. 61/626,308, filed on Sep. 23, 2011.
(60) Provisional application No. 61/626,377, filed on Sep. 26, 2011.
(60) Provisional application No. 61/641,152, filed on May 1, 2012.

(51) Int. Cl. A01M 29/00; G01S 13/56

(52) U.S. Cl. CPC A01M 29/00; G01S 13/56
USPC 342/54; 342/90

(57) ABSTRACT

The system and method of detection of low flying animals, such as birds, bats, and insects, and more particularly the detection of low flying animals using a radar system to detect the animals in three-dimensional airspace. The radar system produces narrowly focused radar pulses. The radar system comprises a single radar unit, an A/D proceeding apparatus, an A/D conversion apparatus, and a pan/tilt controlled base platform. The system and method further producing an avoidance response in an animal, and more particularly, producing an avoidance response by illuminating the animal with ultraviolet light.

### CROSS REFERENCE TO RELATED APPLICATIONS

This Application claims the benefit of U.S. Provisional Application No. 61/626,308, filed Sep. 23, 2011; U.S. Provisional Application No. 61/626,377, filed Sep. 26, 2011; and U.S. Provisional Application No. 61/641,152, filed May 1, 2012, the contents of all of which are incorporated by reference, herein in their entirety.

### FIELD OF THE INVENTION

The present invention relates to the detection of low flying animals, such as birds, bats, and insects, and more particularly to the detection of low flying animals using a radar system to detect the animals in three-dimensional airspace, and to the production of an avoidance response in an animal, and more particularly to the production of an involuntary avoidance response by illuminating the animal, with ultraviolet light.

### BACKGROUND OF THE INVENTION

The present invention relates to the ornithological and entomology field, in the context of detecting, monitoring, and tracking the location of birds and insects in x, y, and z airspace. The need for near real-time detection of their movement is critical to initiate a response to prevent mortality or damage caused from interaction with wind turbines, airplanes, antenna towers, structures and locations, and the like that present a hazard. The need for longer term detection of the movement of flying animals is vital to the study of their patterns of behavior over time.

The present invention will find a particular application in the detection of birds and hats within an energy-producing wind farm that are at risk of direct collision, or flying in close proximity, with the moving blades of the electricity-producing wind turbine resulting, in mortality of the animal and/or damage to the apparatus.

The present invention will also find a particular application in the detection of large-sized species of birds within the airspace of an airplane that is either landing or taking off from an airport. It is recognized that bird strikes often result in mortality, damaged aircraft, delayed operational schedules, and occasionally even fatal air crashes.

The concern of mortality is different with respect to birds of prey (eagles, vultures, kites, and the like) or with respect to other long-flight birds (storks and the like). Specifically, these species have low populations with low reproduction rate. Consequently, the additional mortality for these birds becomes significant for their species and its reduction is a real issue, all the more so since many such species are rare and endangered and are the subject of national and international protection commitments.

The magnitude of the mortalities on species, especially with migratory or endangered species, constitutes a considerable obstacle to the development and the exploitation of wind farms. These concerns have already been the cause of temporary or definitive stoppages in the United States (Altamont Pass, Calif.) and in Spain. There has also been a permanent watch on wind farms by ornithologists (Australia), and a cancellation of installation projects (Germany). These stoppages and the disputes accompanying them are threatening the financial investments associated with the development of renewable wind energy, from the point of view both of development and the exploitation of the wind farms.

Additionally, the risk of bird strikes on aircraft is a concern worldwide. The airports in New York are of particular concern since bird refuge areas of large migratory species are in close proximity to the airports and have resulted in numerous aircraft being damaged and crashing.

The system and method of the present invention, uses the analog signal collected from a series of consecutive radar signals to transform the data into a three-dimensional digital image. The range, bearing, and altitude is determined for each unique object. Slow moving flying objects of interest are discriminated from stationary, fast moving, high-flying objects, or other sources of ‘clutter’.

The present invention also relates to a system for causing animals to leave, or not to enter, a protected airspace by inducing an avoidance response in animals that possess photoreceptors, eryptochrome, or magnetoreceptors. One embodiment of the present invention comprises illuminating the animals with ultra-violet light, which cannot be directly sensed by humans. Examples of animals of particular interest include large raptors, cranes, pelicans, bats, seagulls, waterfowl, and similar birds that are likely to traverse airspace where various pieces of machinery such as wind turbines and airplanes operate. Moreover, flocks of migratory birds and other large body animals present an increased level of risk when compared to individual smaller sized birds and bats that may be foraging or nesting, in such airspace.

Another application of the apparatus of the present invention is the deterrence of birds from landing, nesting, swimming, or feeding at pits containing toxic chemicals including, mining sites, pits filled with drilling waste and chemicals used in well drilling and ‘tracking’ processes, tar pits, and other similar areas. An additional, application is the deterrence of birds from directly feeding at aquaculture farms, such as those used to farm salmon, mussels, and the like, which commonly use pens, rafts, or longlines techniques.

Managing the interaction between animals and other objects in the environment has important commercial, environmental, and social significance. For example, preventing the incursion of animals into airspace that may be directly hazardous to the animal or the operation of machinery, or to people, is desirable. Specific examples include, but are not limited to collisions between birds and airplanes at airports or in flight corridors, collisions between birds and bats, and collisions with wind turbines. Additionally, the loss of production at aquaculture farms due to predation can be reduced.

It is desirable to have a method of causing an animal not to enter, or inducing an animal to leave, a protected airspace to avoid the risk of collisions, unwanted interactions between, animals and humans or machinery, or interactions with toxic environments. Various methods have been employed to reduce the hazard of incursions by animals into protected ground or water areas and low altitude airspace. These methods may include selective hunting of problem species. However, in many cases the problem species is an internationally protected species and hunting is illegal. Non-lethal methods using frightening noises or sights can sometimes be used effectively in controlling transient migratory species, but the effectiveness of these techniques is usually short-lived. Animal management methods such, as habitat modification, intended to deprive animals of food, shelter, space, and water on or around a protected space, have been the most effective longer term tactic for reducing the population of animals. Nevertheless, while techniques that modify the habitat can reduce the risk, these methods are only partially effective and have a limited geographic range.

Others have attempted to solve these problems using various methods. For example, Steffen, U.S. Pat. No. 4,736,907, discloses an apparatus for preventing bird collisions with aircraft by using a plurality of aircraft mounted lights that flash with continuously varying frequency. Philiben, U.S. Pat. No. 6,940,424, discloses a hazard avoidance system for a vehicle that utilizes data related to the location of the collision threat, conditions at the location of a collision threat, and vehicle operating parameters to identify potential animal hazards and select an optimal routine for illuminating a vehicle mounted light to repel the identified hazard. Philiben, U.S. Pat. No. 2010/0236497, discloses a hazard avoidance system that utilizes a surface reflection of light of a wavelength, that induces a response by the animal and Hagstrum, U.S. Pat. No. 6.690,265, discloses a hazard avoidance system for night-migrating birds using a fixed speaker on the structure and playing a continuous broadcast of infrasonic signal, which causes the birds to avoid the structure.

In addition, other systems for managing an animal's relationship to a protected airspace have been described in the literature. Blackwell et al. (2002), U.S.D.A., National Wildlife Research Center Ohio Field Station, published, LASERS AS NON-LETHAL AVIAN REPELLENTS: POTENTIAL APPLICATIONS IN THE AIRPORT ENVIRONMENT and conducted field trials of various Class-II and Class-III, lasers with spectral output between 633-650 nm, and 5-68 mW output power. This suggests that the response of avian species exposed to the long-wavelength lasers will likely prove to be a valuable non-lethal component of integrated bird management plans for airports.

Furthermore, D. Young Jr., W. Erickson, et. al. published a report, National Renewable Energy Laboratory, January 2003, NREL/SR-500-32840, to examine the effects on bird use and mortality of painting wind turbine blades with UV-reflective paint versus those coated with non-UV-reflective paint at the Foote Creek Rim (FCR) Wind Plant in Carbon County, Wyoming. The study did not provide strong evidence that there is a difference in bird use, mortality, or risk, between turbine blades painted with a UV-light reflective paint and those painted with conventional paint. No statistically significant differences existed between fatality rates for the UV and non-UV turbines.

In contrast, one embodiment of the present invention has shown to be a successful method and apparatus for inducing an involuntary avoidance response in an animal by illuminating the animal with light having a peak emission wavelength of between 320-400 nanometers, thereby causing the animal to leave, or not to enter, a protected airspace.

### SUMMARY OF THE INVENTION

It has been recognized that providing an object detection apparatus and method of using a three-dimensional scan, where the apparatus is able to determine whether or not detection results (e.g. measured-direction, elevation, and range data) of a low flying animal obtained by reflections of transmission waves correspond to a risk threat which can then be used to enable the effective suppression of wildlife from a designated area through either directed or non-directed illumination of the area with high brightness ultraviolet lights to induce either an involuntary or voluntary response of avoidance in the animal.

One aspect of the present invention is a system comprising a pulsed radar unit capable of generating and analyzing microwave signals, preferably between 8-12 GHz through an antenna capable of transmitting and receiving a narrow cone of radiation which is scanned through the surrounding three dimensional airspace. The reflected signal is analyzed to identify low flying animal threats from background noises and fast moving objects.

Another aspect of the present invention is the use of ultraviolet light emitting diodes (LED) to illuminate the animals with a high-brightness light. Animals generally are capable of sensing ultraviolet light whereas humans do not. Animals experience involuntary responses of avoidance to unexpected, high-brightness fight, and LED sources do not present the same eye safety concerns associated with lasers.

Another aspect of the present invention is the integration data of risk threats from the radar sensing unit to direct a focused beam of light from an LED source(s) to induce either an involuntary or voluntary avoidance response from animal. The placement of the LED source(s) is more effective when located in close proximity to the designated area that is being “protected” and is most likely to illuminate the eye of the animal.

One aspect of the present invention is a method for detecting the presence of one or more animals, comprising: providing a single radar unit, wherein the radar unit comprises a transmitter and a receiver and the single radar unit transmits microwave of radio wave radiation; collecting a series of data samples from narrowly focused radar pulses, wherein the narrowly focused radar poises vary by an angle of separation that is equal to or less than half of the angle of the beam angle of propagation thereby producing a series of overlapping scans; and determining the range, distance, and altitude of one or more animals.

One embodiment of the method for detecting the presence of one or more animals is wherein the transmitter utilizes an X-band, pulsed radar beam of about 2 kW average power and the receiver is a parabolic dish antenna.

One embodiment of the method for detecting the presence of one or more animals is wherein the pulsed radar beams occur at a pulse repetition frequency. One embodiment of the method for detecting the presence of one or more animals is wherein the pulse repetition frequency is at least 1 KHz.

One embodiment of the method for detecting the presence of one or more animals further comprises the step of providing a pan/tilt controlled motorized base platform upon which the single radar unit is mounted and controlled in azimuth and elevation angle.

One embodiment of the method for detecting the presence of one or more animals is wherein the narrowly focused radar pulses vary by a vertical angle of separation that is equal to or less than 5% of the angle of the beam angle of propagation.

One embodiment of the method for detecting the presence of one or more animals is wherein-the narrowly focused radar pulses vary by a horizontal angle of separation that is equal to or less than 33% of the angle of the beam angle of propagation.

One embodiment of the method for detecting the presence of one or more animals is wherein the pan/tilt controlled motorized base platform is configured to accurately encode the position associated with each unique radar pulse.

One embodiment of the method for detecting the presence of one or more animals further comprises the step of providing an external A/D signal processing apparatus to analyze sequentially consecutive series of radar data into a 3D digital image.

One embodiment of the method for detecting the presence of one or more animals further comprises the step of providing an external A/D signal conversion apparatus, wherein the return analog signal of each radar pulse is sampled and digitized by the external A/D signal.

One embodiment of the method for detecting the presence of one or more animals is wherein the A/D signal conversion apparatus is configured to process data at a rate of at least 1 MHz and a sample depth of at least 10 bits.

One embodiment of the method for detecting the presence of one or more animals further comprises the steps of determining the range to the object by means of signal-time measurements, determining the bearing by means of transmission pulses in the respective azimuth, and determining the altitude of the object by means of successive signal-time measurements as the transmission pulses varies in the respective elevation direction using the A/D signal conversion apparatus.

One embodiment of the method for detecting the presence of one or more animals is wherein the external A/D signal processing apparatus is configured to process signal strength, rate of velocity, variation of a single point in relation to adjacent points in three dimensional airspace, and the variation from previously sampled points in the same three dimensional point in airspace.

One embodiment of the method for detecting the presence of one of more animals is wherein the pan/tilt controlled motorized base platform motion is configured to scan the pulsed radar beams propagated by the parabolic dish antenna faster in the vertical direction as compared to the horizontal direction.

One embodiment of the method for detecting the presence of one or more animals is wherein the external A/D signal processing apparatus incorporates known external conditions, such as wind direction and speed, and known locations of signal returns.

One embodiment of the method for detecting the presence of one of more animals further comprises the steps of providing an external controller unit that interfaces and controls the pan/tilt controlled base platform, the pulse repetition, frequency, the A/D signal conversion apparatus, and the A/D signal processing apparatus.

One embodiment of the method for detecting the presence of one or more animals is wherein the external A/D signal processing apparatus compares the location in three-dimensional space of an animal to a particular set of conditions to determine whether a notification should be sent. One embodiment of the method for detecting the presence of one or more animals is wherein the notification comprises logging, sending a warning, or the like.

Another aspect of the present invention is a method for producing an avoidance response in an animal, comprising; providing a plurality of illumination sources wherein the illumination source is a light-emitting diode having a peak emission wavelength from about 320 nanometers to about 400 nanometers; providing a plurality of sensors; and providing a central controller, wherein the central controller is configured to receive data from the plurality of sensors, combine the data received from the plurality of sensors to create a complete situational awareness, and communicate a response to the plurality of illumination sources thereby producing an avoidance response in an animal.

One embodiment of the method for producing an avoidance response in an animal is wherein the illumination source has a peak emission wavelength from about 355 nanometers to about 390 nanometers.

One embodiment of the method for producing an avoidance response in an animal, is wherein the sensor comprises radar.

One embodiment of the method for producing an avoidance response in an animal further comprises collecting a series of data samples from narrowly focused radar pulses, wherein the narrowly focused radar pulses vary by an angle of separation that is equal to or less than half of the angle of the beam angle of propagation thereby producing a series of overlapping scans; and.

One embodiment of the method for producing an avoidance response in an animal is wherein the situational awareness comprises the range, distance, and altitude of one or more animals.

One embodiment of the method for producing an avoidance response in an animal is wherein the animal is a flying animal. One embodiment of the method for producing an avoidance response in an animal is wherein the animal is a swimming animal. One embodiment of the method for producing an avoidance response in an animal is wherein the animal is a diving animal.

One embodiment of the method for producing an avoidance response in an animal, is wherein the avoidance response is an involuntary response resulting from a brightness contrast to the apparent background brightness from the perspective of the animal of at least a 10:1 ratio and the illumination intensity is less than 0.6 W/cm².

One embodiment of the method for producing an avoidance response in an animal is wherein the avoidance response is an involuntary response resulting from an induced oscillating eye pupil dilation resulting from a changing illumination state between ‘on’ and ‘off’ conditions with a time interval from about 100 milliseconds to about 5 seconds.

One embodiment of the method for producing an avoidance response in an animal is wherein the spatial separation of the plurality of illumination sources is an angular amount from about 1 degree to about 15 degrees.

One embodiment of the method for producing an avoidance response in an animal is wherein the response communicated by the central controller to the plurality of illumination sources is configured to modify the intensity, direction, sequence, duration of illumination, and any combination thereof.

One embodiment of the method for producing an avoidance response in an animal is wherein the sensor is configured to differentiate between objects such as low flying animals and larger, faster moving objects that are within the protected area.

One embodiment of the method for producing an avoidance response in an animal is wherein the sensor is configured to utilize signal processing of multiple samples over time to differentiate objects with a low signal to noise ratio that exhibit persistence of motion characteristic of animals of interest front general background signal noise within the protected area.

One embodiment of the method for producing an avoidance response in an animal is wherein the central controller communicates with the sensors and illumination sources using data packets and TCP protocols over a wireless network.

One embodiment of the method for producing an avoidance response in an animal is wherein the central controller determines the appropriate response to the moving objects of interest using rules of escalating responses to issue illumination commands consisting of range, bearing azimuth, power level of emission, duration of emission, and coordinated flashing sequence to each illumination source to be directed at the moving object of interest.

Another aspect of the present invention is a system for producing an avoidance response in an animal, comprising; a plurality of illumination sources wherein the illumination source is a light emitting diode; a plurality of sensors, and a central controller configured to receive data from the plurality of sensors, combine the data received from the plurality of sensors to create a complete situational awareness, and communicate a response to the plurality of illumination sources thereby producing an avoidance response in an animal.

One embodiment of the system for producing an avoidance response in an animal is wherein the plurality of illumination sources is configured to illuminate the rotor sweep area and surrounding airspace of a wind turbine with light having a peak emission wavelength from about 370 nanometers to about 400 nanometers.

One embodiment of the system for producing an avoidance response in an animal further comprises a power supply, power relay, controller electronics, and thermistors.

One embodiment of the system for producing an avoidance response in an animal is wherein, the plurality of illumination sources conforms to the standard aircraft industry landing light configuration for dimensions and power specifications and has a peak emission wavelength from about 355 nanometers to about 400 nanometers.

One-embodiment of the system for producing an avoidance response in an animal is wherein the plurality of illumination sources is directed to the airspace directly in front of the aircraft which overlaps the airspace illuminated by the aircraft's traditional landing lights.

One embodiment of the system for producing an avoidance response in an animal further comprises a plurality of illumination sources that are configured to emit light having a peak emission wavelength from about 400 nanometers to about 700 nanometers.

One embodiment of the system for producing an avoidance response in an animal further comprises a power supply, electronic controller, and power relay switch.

One embodiment of the system for producing an avoidance response in an animal is wherein the illumination sources are configured to alternate between ‘on’ and ‘off’ conditions with a time interval from about 100 milliseconds to about 1.5 seconds.

One embodiment of the system for producing an avoidance response in an animal is wherein the illumination sources are configured to alternate between ‘on’ and ‘of’ conditions in response to an over temperature condition.

These aspects of the invention are not meant to be exclusive and other features, aspects, and advantages of the present invention will be readily apparent to those of ordinary skill in the art when read in conjunction with the following description, appended claims, and accompanying drawings.

### BRIEF DESCRIPTION OF THE DRAWINGS

The foregoing and other objects, features, and advantages of the invention will be apparent from the following description of particular embodiments of the invention, as illustrated in the accompanying drawings in which like reference characters refer to the same parts throughout the different views. The drawings are not necessarily to scale, emphasis instead being placed upon illustrating the principles of the invention.

FIG. 1 shows a radar system of the prior art.

FIG. 2 shows diagrams of pulsed signal radar of the prior art.

FIG. 3 shows the absorption of radiation by water.

FIG. 4 shows the absorption of radiation by water.

FIG. 5 shows a radar system of the present invention.

FIG. 6 is a graph showing that the four pigments of the estrildid finch cones extend the range of color vision into the ultraviolet region.

FIG. 7 is a graph of power density versus exposure time for various wavelengths to avoid human hazards such as burn to the retina or skin.

FIG. 8 is a plot showing gaseous attenuation in units of dB/km for oxygen and water vapor for radar wavelengths that are commonly known as marine radar.

FIG. 9 is a table of published studies identifying power (W/cm²) to induce change in pupil dilation and retinal detection of motion and power level of varying ‘open sky’ lighting conditions.

FIG. 10 is a schematic illustration of one embodiment of the present invention.

FIG. 11 is an illustration for the system interactions of one embodiment of the present invention.

FIG. 12 is a flow diagram of a method of one embodiment of the present invention.

FIG. 13 is an illustration of a utility size wind turbine with a light illumination system of a method of one embodiment of the present invention.

FIG. 14 is an illustration of an integrated aircraft landing light with UV light source of a method of one embodiment of the present invention.

FIG. 15 shows one embodiment of the system of the present invention.

FIG. 16 shows one embodiment of the system of the present invention.

FIG. 17 shows one embodiment of the system of the present Invention.

FIG. 18 shows one embodiment of the system of the present invention.

FIG. 19 shows one embodiment of the system of the present invention.

FIG. 20 shows the results of tracking animals using one embodiment of the present invention.

FIG. 21 shows field tests from one embodiment of the system of the present invention.

FIG. 22 shows one embodiment of the method of the present invention.

### DETAILED DESCRIPTION OF THE INVENTION

The most effective detection systems include means for detecting and estimating distance by radio waves, namely radars (for “RAdio Detection And Ranging”). The use of radar is widely used in order to study low flying animal movements, especially at the time of migrations.

Radars are commonly used for detecting and measuring distances of objects in space by transmitting and receiving microwave electromagnetic waves. The execution modalities and the practical applications are extremely varied, but the most widely used and the most financially affordable devices are currently radars of the “marine” type. Marine-type radars are usually rotating radars, with X-band, S-band or L-band pulsing. The beam angle height of these radars is approximately 20° by 2°.

These radars are usually used in the horizontal plane, namely the median of the vertical angle of the transmission beam is parallel with the horizon. The objects detected in the transmission beam of the radar waves are commonly projected onto the median of the vertical angle of said transmission beam. Said detected objects are then represented in the form of one or more echoes in a two-dimensional plane.

A major drawback of this detection method is that the resulting echo is imprecise in terms of dimensions and position, particularly in altitude. This is due to the fact that the further the object is from the radar wave transmission source, the less reliable the detection is due to the decreasing strength of the return signal. The small size of the radar cross section for birds compared to an airplane further reduces the return signal strength. The lack of precise information in the elevation angle of the return signal does not enable the determination of the elevation without having additional information.

Numerous techniques to determine the positions and direction of flying objects include the use of multiple radars, multiple pulses, multiple frequencies, or the analysis of the return signal phase characteristics (I and Q), commonly known as Doppler analysis.

Consequently, tire problem arises that detection, with sufficient accuracy and reliability, of the position of low flying objects of interest is difficult such that warnings or other corrective actions cannot betaken appropriately. Thus, detection must be carried out in a three-dimensional space, with altitude determined to within several meters, and at a considerable range of distances to provide the accuracy needed to practice the present invention.

One aspect of the present invention detects low flying objects of interest with great sensitivity and reliability in three-dimensional airspace. One embodiment of the present invention is a method for determining whether a received signal has been returned from a flying animal moving at or above a threshold speed, range, bearing, or altitude.

It is recognized that it is desirable to detect accurately and reliably objects of interest in three-dimensional airspace. It is also recognized that in ranging and detection systems a signal transmitted to detect a target may be returned by other objects. These ‘false alarm’ signals, also known as ‘clutter’ are undesirable for numerous reasons.

Processing of the signal for determining the location of a flying animal, in three-dimensional space requires having more information than what is available in a traditional radar scan. The processing of range and bearing information is well understood with traditional radar systems. The processing of altitude information requires significantly more samples that have been collected in a manner where the conditions have been varied slightly by a known amount.

Traditional T-bar type antenna designs are known to have significant side lobe and back lobe sensitivity that contribute to the reporting of ‘false alarms’. Furthermore, T-bar type antennas typically have a larger than desired angle of sampling which makes determining altitude with any degree of accuracy difficult. Parabolic antennas are known to have a narrow field of emission, exhibit minimal side lobe and back lobe emission, have high gain performance, and are relatively inexpensive.

Generally speaking, the common components for a radar system are a transmitter that generates radio signals with an oscillator such as a klystron or a magnetron and controls its duration by a modulator; a waveguide that links the transmitter and the antenna; a duplexer that serves as a switch between the antenna and the transmitter or the receiver for the signal when the antenna is used in both situations; and a receiver. Knowing the shape of the desired received signal (a pulse), an optimal receiver can be designed using a matched filter.

Data collection of signal strength return from an object having a radar cross section involve power, or phase (I and Q) sampling techniques for signals generated from either magnatrons or klystrons. Signal processing techniques include, but are not limited to Doppler processing, simple power calculations, kernel processing, and complex digital signal processing techniques. A variety of notch filter techniques and tracking algorithms are also generally known to those of ordinary skill in the art.

X-band (9.5 GHz) radar is known as a marine radar band. It is generally known by fishermen that X-band radars are preferred for locating flocks of birds in the ocean which indicates the location of where birds are feeding on fish, and are thus close to the surface of the water. S-band (3 GHz) and G-band (5.5 GHz) are also used for marine and weather applications but exhibit a lower signal return to water.

It is recognized that the bodies of birds and bats are composed mostly of water. The corresponding radial depth of absorption, and reflection of tissue varies for different frequencies of radiations, size, and inter-spatial differences between blood vessels, muscle and bones of the object, and the like.

The sudden change in the radar cross section (“RCS”) of a signal return in airspace is a known as the ‘glint’ effect. This means that echo signals appear and disappear randomly. Common signal processing techniques used to minimize ‘glint’ include simply increasing the threshold of response, or increasing the time that a ‘glint’ is required to remain in the area before it is reported. A variety of unwanted ‘clutter’ sources results in some signal returns from usually stationary objects which have sufficient RCS to exceed the threshold of detection. The common technique of reducing ‘glint’ and ‘clutter’ results in a general reduction of sensitivity or probability of detection of an airborne object.

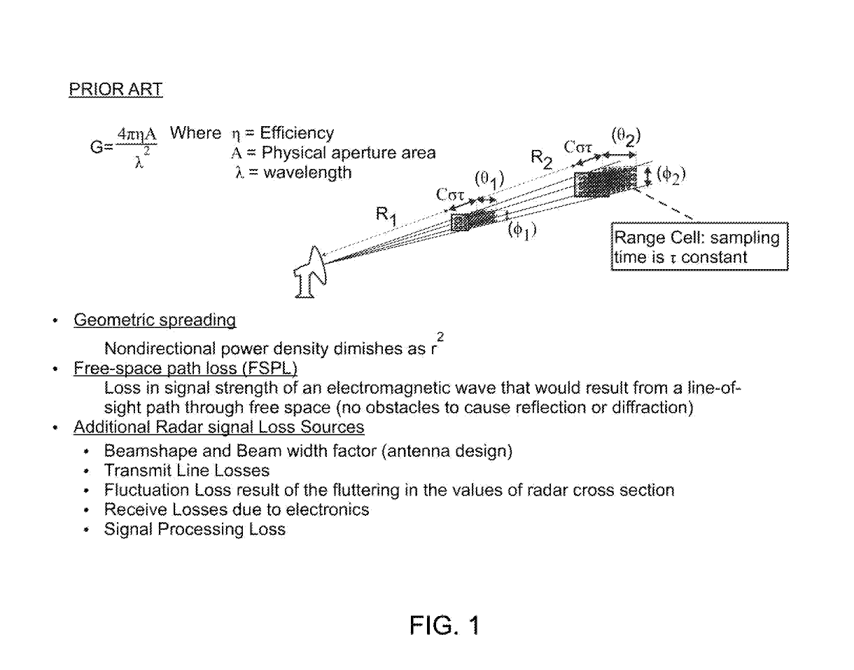

Referring to FIG. 1, the pulsed radar energy propagates outward from the source through the antenna. The energy geometrically decreases as the surface area of the sphere increases.

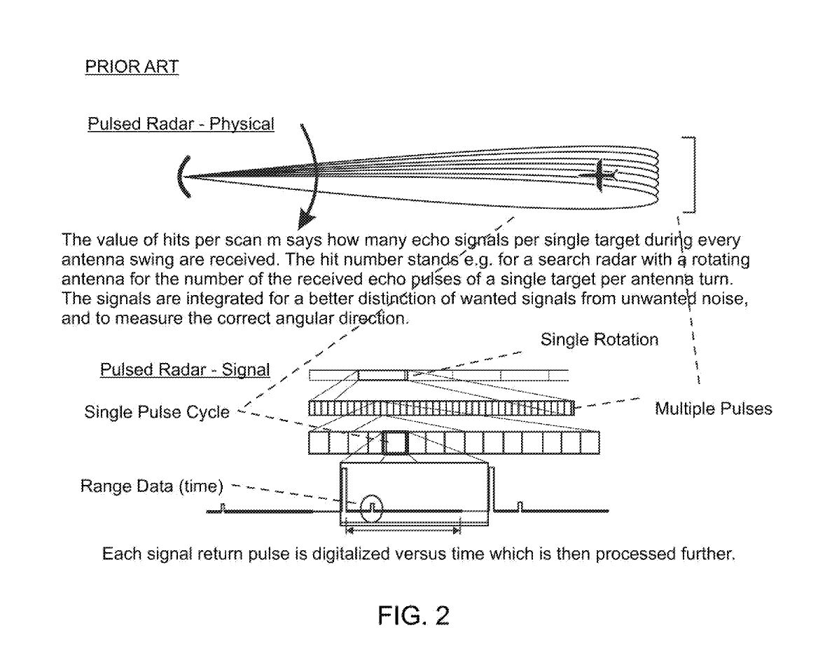

Referring to FIG. 2, multiple sequential pulses of radar energy strike the object. The object size, shape, and reflectivity determine the amount of energy which is reflected back to the antenna. The antenna then receives the analog return signal. The analog signal is converted to a digital signal with a high rate of sampling. The distance that the object is from the radar unit is calculated from the time that is required for the radar pulse to travel to and from the object.

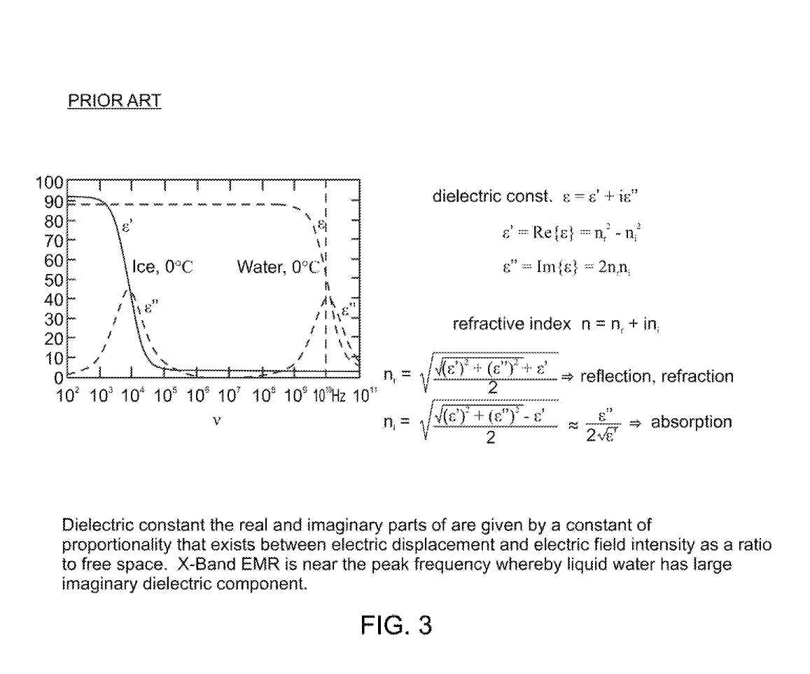

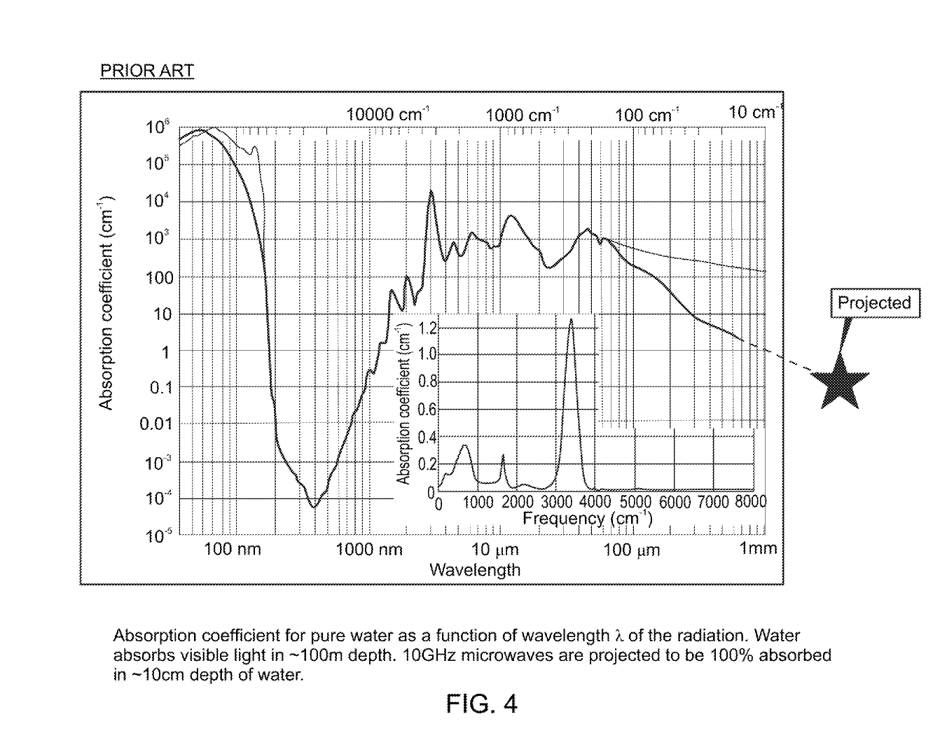

Referring to FIG. 3, the radar energy that strikes water is reflected, refracted, or absorbed. Water strongly reflects 10 GHz microwave energy versus longer or shorter wavelengths, which is a now strongly polarized. Referring to FIG. 4, the depth of absorption of 10 GHz energy in water is approximately 10 cm.

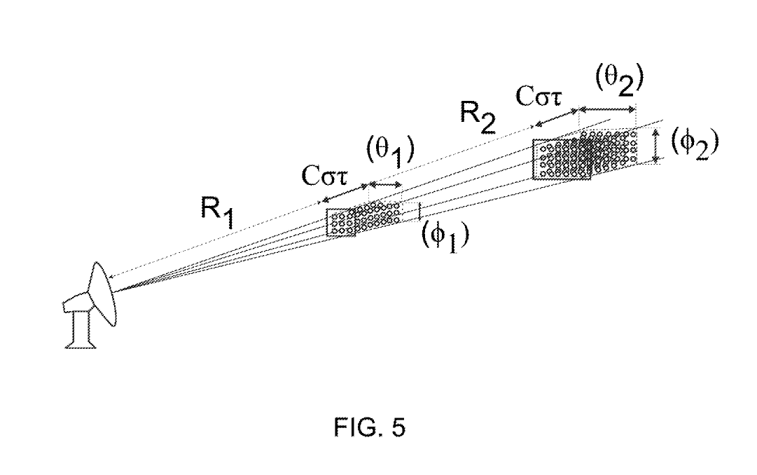

Referring to FIG. 5, the parabolic dish in the system of the present invention is rapidly scanned in the vertical direction, while being slowly scanned in the horizontal direction. A large number of overlapping scans in the vertical direction provides statistically significant data of a varying condition from which precise altitude information of objects can be derived. The parabolic dish has a small cone angle of emission which greatly reduces the amount of unwanted signal noise that is sampled.

In certain embodiments, due to the overlapping nature of the scans, a number of pulses may interact with the target. In one embodiment there may be about 2 pulses, about 3 pulses, about 4 pulses, about 5 pulses, about 6 pulses, about 7 pulses, about 8 pulses, about 9 pulses, or about 10 pulses. In one embodiment, there may be about 11pulses, about 12 pulses, about 13 pulses, about 14 pulses, about 15 pulses, about 16 pulses, about 17 pulses, about 18 pulses, about 19 pulses or about 20 pulses. In one embodiment there may be about 21 pulses, about 22 pulses, about 23 pulses, about 24 pulses, about 25 pulses, about 26 pulses, about 27 pulses, about 28 pulses, about 29 pulses or about 30 pulses, in one embodiment there may be about 31 pulses, about 32 pulses, about 33 pulses, about 34 pulses, about 35 pulses, about 36 pulses, about 37 pulses, about 38 pulses, about 39 pulses or about 40 pulses. In one embodiment there may be about 41 pulses, about 42 pulses, about 43 pulses, about 44 pulses, about 45 pulses, about 46 pulses, about 47 pulses, about 48 pulses, about 49 pulses or about 50 pulses.

In certain embodiments, the narrowly focused radar pulses vary by a vertical angle of separation that is equal to or less than about 5% of the angle of the beam angle of propagation. In one embodiment the vertical angle of separation is about 2%, about 3%, about 4%, about 5%, about 6%, about 7% , about 8%, about 9%, or about 10%. in one embodiment the vertical angle of separation is about 11%, about 12%, about, 13%, about, 14%, about 15%, about 16% , about 17%, about 18%, about 19%, or about 20%. In one embodiment the vertical angle of separation is about 21%, about 22%, about 23%, about 24%, about 25%, about 26% , about 27%, about 28%, about 29%, or about 30%. In one embodiment the vertical angle of separation is about 3.1%, about 32%, about 33%, about 34%, about 35%, about 36% , about 37%, about 38%, about 39%, or about 40%. In one embodiment the vertical, angle of separation is about 41%, about 42%, about 43%, about 44%, about 45%, about 46%, about 47%, about 48%, about 49%, or about 50%.

In certain embodiments, the narrowly focused radar pulses vary by a horizontal angle of separation that is equal to or less than 33% of the angle of the beam angle of propagation, in one embodiment the horizontal angle of separation is about 2%, about 3%, about 4%, about 5%, about 6%, about 7% , about 8%, about 9%, or about 10%. In one embodiment the vertical angle of separation Is about 11%, about 12%, about 13%, about 14%, about 15%, about 16% , about 17%, about 18%, about 19%, or about 20%. In one embodiment the vertical angle of separation is about 21%, about 22%, about 23%, about 24%,-about 25%, about 26% , about 27%, about 28%, about 29%, or about 30%. In one embodiment the vertical angle of separation is about 31%, about 32%, about 33%, about 34%, about 35%, about 36% , about 37%, about 38%, about 39%, or about 40%. In one embodiment the vertical angle of separation is about 41%, about 42%, about 43%, about 44%, about 45%, about 46% , about 47%, about 48%, about 49%, or about 50%.

In one embodiment of the present invention, a method for detecting the presence of one or more flying animals, comprises providing a single radar unit, wherein the radar unit comprises a transmitter and a receiver and the single radar unit transmits microwave or radio wave radiation; collecting a series of data samples from narrowly focused radar pulses, wherein the narrowly focused radar pulses vary by an angle of separation that is equal to or less than half of the angle of the beam angle of propagation thereby producing a series of overlapping scans; and determining the range, distance, and altitude of one or more flying animals.

In certain embodiments, the transmitter utilizes an X-band, pulsed radar beam and the receiver is a parabolic dish antenna. In certain embodiments, the pulsed radar beams comprise a predetermined number N of predetermined sequences Bs, where x=1, . . . , N of K-modulated transmission pulses.

In certain embodiments, the pulsed radar beams occur at a pulse repetition frequency of at least 1 KHz. In one embodiment, the pulse repetition frequency is about 2 kHz, about 3 kHz, about 4 kHz, about 5 kHz, about 6 kHz, about 7 kHz, about 8 kHz, about 9 kHz, or about 10 kHz. In one embodiment, the pulse repetition, frequency is about 11 kHz, about 12 kHz, about 13 kHz, about 14 kHz, about 15 kHz, about 16 kHz, about 17 kHz, about 18 kHz, about 19 kHz, or about 20 kHz. In one embodiment, the pulse repetition frequency is about 21 kHz, about 22 kHz, about 23 kHz, about 24 kHz, about 25 kHz, about 26 kHz, about 27 kHz, about 28 kHz, about 29 kHz, or about 30 kHz.

In certain embodiments, the method for detecting the presence of one or more flying animals further comprises the step of providing a pan/tilt controlled motorized base platform upon which the single radar unit is mounted and controlled in azimuth and elevation angle. In certain embodiments, the pan/tilt controlled motorized base platform is configured to accurately encode the position associated with each unique radar pulse.

In one embodiment of the present invention., the method for detecting the presence of one of more flying animals further comprises the step of providing an external A/D signal processing apparatus to analyze sequentially consecutive series of radar data into a 3D digital image. In certain embodiments, the return analog signal of each radar pulse is sampled and digitized by the external A/D signal.

In one embodiment of the present invention, the A/D signal conversion, apparatus is configured to process data at a rate of at least 1 MHz. In one embodiment, the rate is about 2 MHz, about 3 MHz, about 4 MHz, about 5 MHz, about 6 MHz, about 7 MHz, about 8 MHz, about 9 MHz, about 10 MHz. In one embodiment, the rate is about 11 MHz, about 12 MHz, about 13 MHz, about 14 MHz, about 15 MHz, about 16 MHz, about 17 MHz, about 18 MHz, about 19 MHz, or about 20 MHz. In one embodiment, the rate is about 21 MHz, about 22 MHz, about 23 MHz, about 24 MHz, about 25 MHz, about 26 MHz, about 27 MHz, about 28 MHz, about 29 MHz, or about 30 MHz. In one embodiment, the rate is about 31 MHz, about 32 MHz, about 33 MHz, about 34 MHz, about 35 MHz, about 36 MHz, about 37 MHz, about 38 MHz, about 39 MHz, or about 40 MHz. In one embodiment, the rate is about 41 MHz, about 42 MHz, about 43 MHz, about 44 MHz, about 45 MHz about 46 MHz, about 47 MHz, about 48 MHz, about 49 MHz, or about 50 MHz. In one embodiment, the rate is about 51 MHz, about 52 MHz, about 53 MHz, about 54 MHz, about 55 MHz, about 56 MHz, about 57 MHz, about 58 MHz, about 59 MHz, or about 60 MHz. In one embodiment, the rate is about 61 MHz, about 62 MHz, about 63 MHz, about 64 MHz, about 65 MHz, about 66 MHz, about 67 MHz, about 68 MHz, about 69 MHz, or about 70 MHz. In one embodiment, the rate is about 71 MHz, about 72 MHz, about 73 MHz, about 74 MHz, about 75 MHz, about 76MHz about 77 MHz, about 78 MHz, about 79 MHz, or about 80 MHz. In one embodiment, the rate is about 81 MHz, about 82 MHz, about 83 MHz, about 84 MHz, about 85 MHz, about 86 MHz, about 87 MHz, about 88 MHz, about 89 MHz, or about 90 MHz. In one embodiment, the rate is about 91 MHz, about 92 MHz, about 93 MHz, about 94 MHz, about 95 MHz, about 96 MHz, about 97 MHz, about 98 MHz, about 99 MHz, or about 100 MHz.

In one embodiment of the present invention, the A/D signal conversion apparatus is configured to process data at a sample depth of at least 10 bits. In one embodiment the sample depth is about 5 bits, about 6, bits, about 7, bits, about 8 bits, about 9 bits, or about 10 bits. In one embodiment the sample depth is about 11 bits, about 12 bits, about 13 bits, about 14 bits, about 15 bits, about 16 bits, about 17 bits, about 18 bits, about 19 bits, or about 20 bits.

In one embodiment of the present invention, the method for detecting the presence of one or more flying animals further comprises the steps of determining the range to the object by means of signal-time measurements, determining the bearing by means of transmission pulses in the respective azimuth, and determining the altitude of the object by means of successive signal-time measurements as the transmission pulses varies in the respective elevation direction using the A/D signal conversion apparatus.

In certain embodiments, the external A/D signal processing apparatus is configured to process signal strength, rate of velocity, variation of a single point in relation to adjacent points in three dimensional airspace, and the variation from previously sampled points in the same three dimensional point in airspace.

In certain embodiments, the pan/tilt controlled motorized base platform motion is configured to scan the pulsed radar beams propagated by the parabolic dish antenna faster in the vertical direction as compared to the horizontal direction. In certain embodiments, the external A/D signal processing apparatus incorporates known external conditions, such as wind direction and speed, and known locations of signal returns.

In certain embodiments, the method for detecting the presence of one or more flying animals further comprises the steps of providing an external controller unit that interfaces and controls the pan/tilt controlled base platform, the pulse repetition frequency, the A/D signal conversion apparatus, and the A/D signal processing apparatus.

In certain embodiments, the external A/D signal processing apparatus compares e location in three-dimensional space of a flying animal to a particular set of conditions to determine whether a notification should be sent. In certain embodiments, the notification comprises logging, sending a warning, or the like.

Detecting, monitoring, and tracking the location of animals, such as birds, bats, and insects in three-dimensional space using a radar system is critical to assess the need to initiate a response in an animal to prevent mortality or damage caused from the animals' interaction with wind turbines, airplanes, antenna towers, structures and locations, and the like that may present a hazard. The production of an avoidance response in an animal by illuminating the animal with ultraviolet light helps prevent mortality and/or damage caused from such interactions.

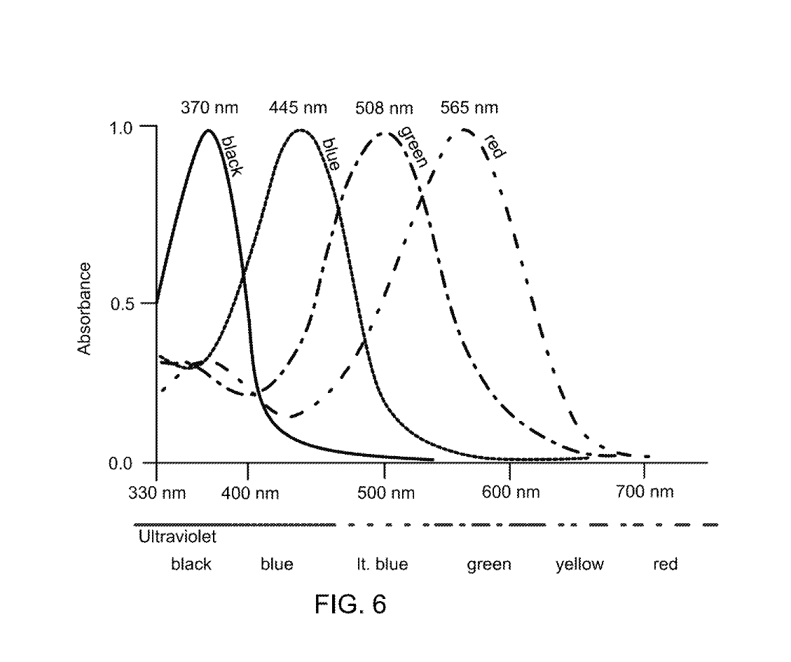

Referring to FIG. 6, studies of the avian retina indicate that birds can distinguish light with a wavelength ranging from approximately 325 nm (ultraviolet) through the range of wavelengths visible to humans (about 400 nm to about 700 nm). While human color vision is based on three color channels, birds are generally considered to be tetrachromatic, and some species may even be pentachromatic. A tetrachromatic vision system can distinguish four primary colors: ultraviolet (UV), blue, green, and red corresponding to the peaks in the spectral absorption probability.

The relationship of the behavior of animals to the perception of a light source as it is being illuminated can vary significantly. When the animal is initially illuminated with a directed beam of light, the response can range from a mild voluntary reaction to a strong involuntary reaction, which is dependent upon the power level and perceived pattern of motion observed by the animal.

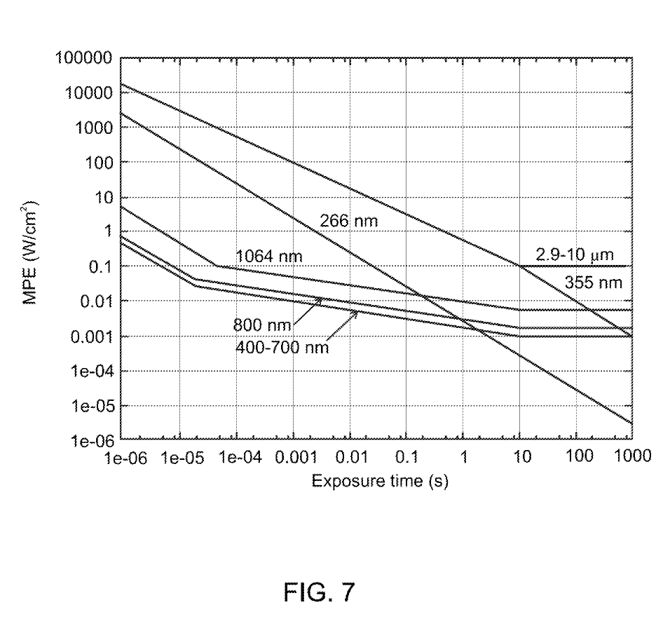

Referring to FIG. 7, the maximum permissible exposure (MPE) for humans is the highest power or energy density (in W/cm² or J/cm²) of a light source that is considered safe, i.e. that has a negligible probability for creating damage. The safe standard for humans is usually defined as about 10% of the dose that has a 50% chance of creating damage under worst case scenarios. The MPE in power density is identified for varying exposure time for various wavelengths according to international standard IEC 60825 for lasers to avoid potential human injuries such as burn to the retina of the eye, or even the skin. In addition to the wavelength and exposure time, the MPE takes into account: the spatial distribution of the light (from a laser or otherwise). The worst-case scenario is assumed, in which the eye lens focuses the light into the smallest possible spot size on the retina for the particular wavelength and the pupil is fully open. Although the MPE is specified as power or energy per unit surface, it is based on the power or energy that can pass through a fully open human pupil (0.39 cm²) for visible and near-infrared wavelengths.

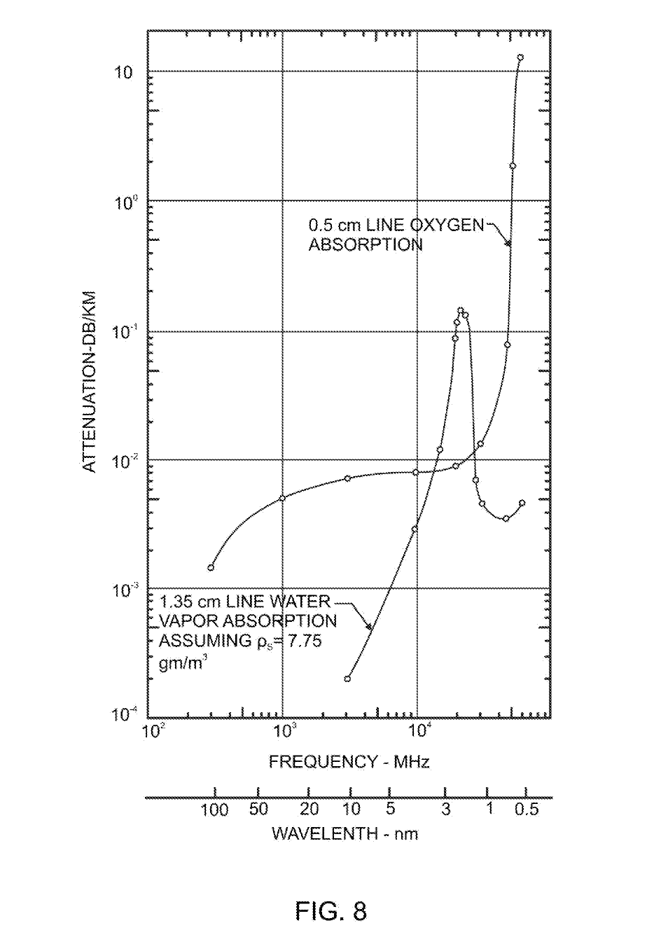

Referring to FIG. 8, the attenuation by water and oxygen gases is associated with absorption. Scattering is negligible over a range of radar wavelengths. For molecules like water vapor and oxygen, vibrational and rotational states are excited by microwave radiation. As the molecule relaxes to its ground state, the absorbed energy is either radiated by the molecule or taken up as an increase in internal energy by the molecules (heating). It is known that the attenuation increases as the concentration of water molecules increases. For example, water, fat, and other substances in food absorb energy from microwaves in a process called dielectric heating. Many molecules (such as those of water) are electric dipoles, meaning that they have a partial positive charge at one end and a partial negative charge at the other, and therefore rotate as they try to align themselves with the alternating electric field of the microwaves. The radar energy in the electric dipole molecule is either absorbed or reflected. This molecular movement represents heat which is then dispersed as the rotating molecules hit other molecules and put them into motion. Water vapor molecular resonance efficiently occurs at frequencies above 20 GHz. Penetration depth of microwaves is dependent on the frequency, with lower microwave frequencies penetrating further. Water in a liquid state efficiently reflects radar energy. Thus, marine band radars, especially X-band with emissions between 8 and 12 GHz, have commonly been associated with good sensitivity to detect birds.

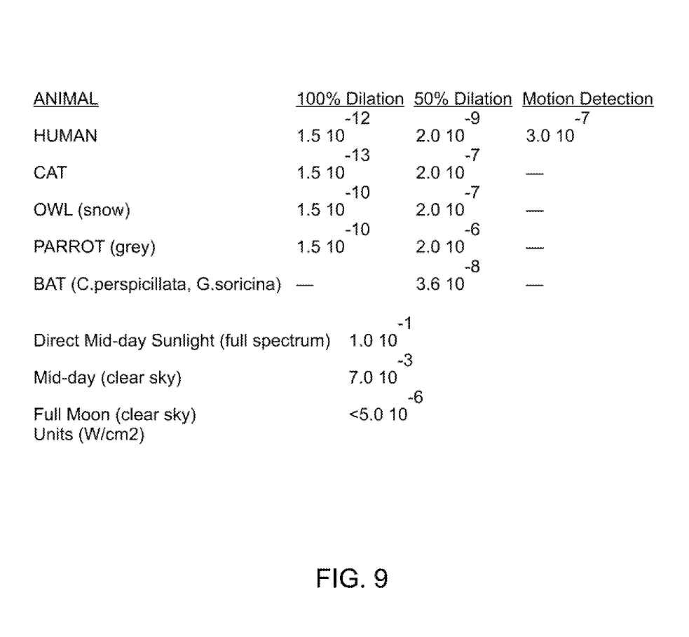

Referring to FIG. 9, the power (in W/cm²) of a light impinging upon, various animals that is required to initiate an involuntary response and detection of motion is shown. The light source that directly illuminates the animals should be greater than the power levels identified to cause eye dilation in dark conditions. This value increases when ambient illumination also increases. In one embodiment, directed illumination consisting of a beam of 380 nm+/−20 nm light with an intensity of 10⁻⁵ W/cm² in bright midday light conditions has been observed to induce Red-tailed Hawk (Buteo jainaicensis), a diurnal raptor, to egress the area soon after being illuminated. Similar results were observed with Starling (Sturnus Vulgaris), a passerine. The same directed illumination intensity of Little Brown Bat (Myotis lucifungus) approximately 30 minutes after sunset induces an immediate change in the flight path and usually results in the bats egressing the airspace after 15-30 minutes of being repeatedly illuminated. Mallard ducks (Anas Platyrhynchos) that are frequently fed old bread by humans responds to an intensity of 10⁻⁶ W/cm² in bright midday light conditions by either swimming or flying towards the light source but would move away when intensities exceeded 10⁻³ W/cm². Light conditions, time of day, and instinctual behavior of the animal may determine the response to the sensory cues delivered by directed illumination. Similar behavioral responses have been observed with a wide range of avian species.

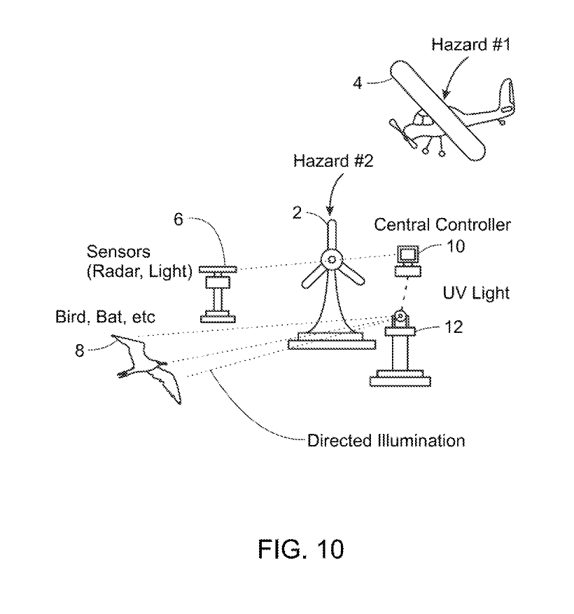

The present invention is a system for using ultraviolet light to induce an animal to leave an area by using varying power levels and coordinated patterns of illumination directed upon, the animals as it traverses the airspace. For example in FIG. 10, the stationary 2 or moving 4 hazards are located within the protected airspace. A sensor 6 or a series of sensors are deployed to locate a moving object that has the characteristics of a low flying animal 8. Once the location of the low flying animal 8 is identified, the range, speed, and bearing data are entered into a data packet that is transmitted to the central controller 10 rising TCP protocols. The central controller 10 then fuses the data, determines the threat level and response to be taken against the threat, and uniquely commands each UV light source 12 using data packets and TCP protocols directly to illuminate the low flying animal 8, which will induce a response resulting in the low-flying animals leaving the area. The artificial UV light source 12 may be adaptively operated by a central control system and may comprise a single sensor and a single light source or a plurality of sensors or light sources. A single light source or a plurality of sensors or light sources may operate by illuminating a predetermined region of the airspace independently or in a coordinated manner without input from any sensors. The UV light sources output has peak emission wavelength that is not visible to the normal human vision system.

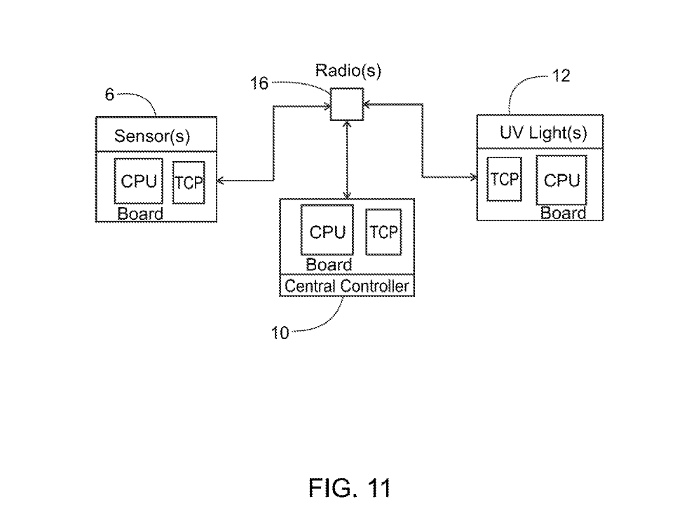

The system diagram of FIG. 11 illustrates the illumination sources and sensors. In one embodiment of the present invention, the sensors comprise radar or lidar systems that are capable of detecting low flying animals, which are often located at the perimeter of the airspace that is to be protected. The number and location of illumination sources and sensors may vary to match the requirements and complexity of the area to be protected. The illumination, sources and sensors may or may not be collocated. A single sensor and illumination source may act autonomously. Single or multiple illumination sources may act autonomously, or multiple illumination sources may have a synchronized illumination pattern when observed by the animal depending on the particular application.

Still referring to FIG. 11, multiple illumination sources and sensors may communicate with a central controller 10 using either a wire or wireless network 16. Sensors 6 identify the azimuth, and range of low flying animals that are within the protected airspace. The central controller 10 determines proximity of the animals to the protected airspace and communicates the individual or coordinated illumination response to each of the illumination sources 12 individually. The illumination command to each illumination source includes unique commands concerning direction, power level of emission, duration of emission, and coordinated flashing sequence to be followed. The central controller 10 may utilize an escalating sequence of illumination protocols directed at the approaching animals to induce responses ranging from a voluntary alert and avoidance to an acute involuntary escape response. The central control unit 10 aggregates the data from all available sensors 6 to create a threat assessment to the protected airspace.

In one embodiment of the present invention, the response escalates to match the severity of the threat assessment. The lowest level of illumination protocol response is to illuminate the animal with a low power level designed to cause pupil dilation and elicit a voluntary alert and awareness response. The next level of illumination protocol response is to illuminate the animal with a coordinated flashing from multiple illumination sources to cause the perception of motion. The next higher level of illumination protocol response is to illuminate the animal with a coordinated high-intensity flashing from multiple illumination sources to cause, the involuntary startled or dazzled response. The highest level of illumination protocol response is to illuminate with a coordinated constant high-intensity illumination from multiple illumination sources to cause the involuntary acute escape response. At no time is the animal illuminated with a power level that may cause eye damage.

The method of managing the interactions between animals and a wide variety of objects that are located within the protected airspace may include a wide variety of different objects ranging from stationary objects, to objects that enter, transit, or leave the airspace. Pulsing lights that are attached to machinery provide a method of controlling the interaction of an animal and an object; these systems have characteristics that limit their effectiveness and desirability in many applications. Flashing light systems typically rely on the fixation of the animal with one or more point sources of light emissions, and thus the effectiveness of the system is likely to be strongly influenced by the angle of approach of the animal to the object to which the light, source is attached. For example, it may be difficult or impractical to provide light sources that are visible to animals that are free, to approach the machinery from varying directions. A more effective method results when an escalation sequence of illumination to the animal progresses from general involuntary eye dilation to create awareness, to a sequence of illumination to the animal that creates a perception of motion, to a strong illumination that invokes an increased acuteness inducing an involuntary escape reaction. The escalation sequence corresponds to transitioning from voluntary to involuntary responses, in one embodiment of the present invention, the transition is to a flash frequency from a constant illumination for two or more separated light sources that appear to have a high rate of speed of results in removing an animal from a protected area.

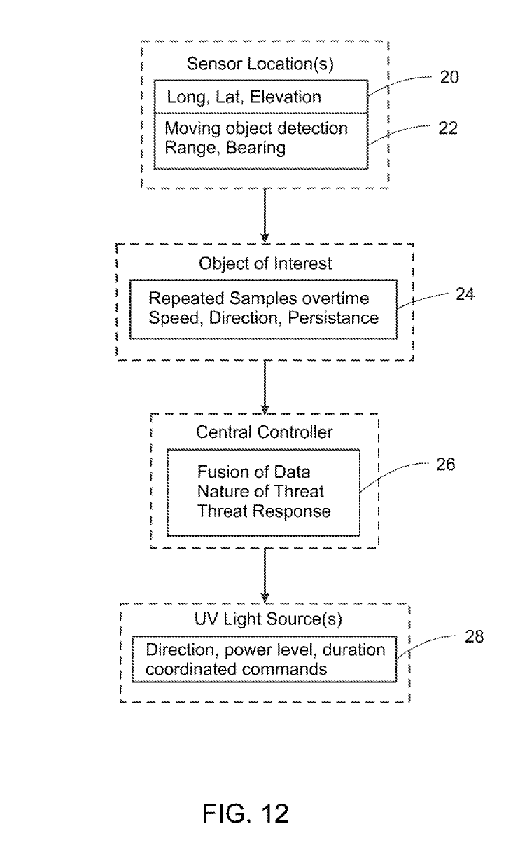

A block diagram of one embodiment of the method of the present invention is shown, in FIG. 12. There, a sensor detects movement of objects through the airspace being monitored to protect the airspace 20. There, the sensor can be radar, lidar, or a combination of both 22. The motion characteristics of objects detected 24 include speed, size of the object, signal strength of return, distance to the object, and direction of travel of the object. The motion characteristics are used to differentiate animals from other objects such as airplanes, wind turbines, or other machinery. Only objects having motion characteristics of animals of interest are transmitted 26 to the central controller. The characteristics of motion front each sensor are transmitted to a central control processor using either wireless or wired TCP protocols. The central control processor fuses the data to create a composite understanding of the activities occurring within the airspace. The central control processor aggregates the data and determines the appropriate threat response for the objects being tracked and commands the light sources to illuminate the objects 28. The commands can range from a single light illuminating the objects traveling through the airspace, to a coordinated illumination by multiple lights from different locations which are initiated to cause the animals to leave the area.

One embodiment of the central controller is similar to a personal computer system. The central controller may be controlled by other devices, such as a programmable timer, which may be integral to an on-board computer or may be a stand-alone system capable of communicating with other computers and instruments. The central controller receives data from a plurality of sensors, processes the data according to instructions, sends instructions to a plurality of UV light sources, and stores the result in the form of signals to control the UV light source via data packets using TCP protocol. In one embodiment of the present invention; the central controller operates one or more of the UV light sources in accordance with, a plurality of routines in an application program stored on a mass storage unit. In one embodiment for the present invention, a light illumination routine comprises an instruction, executable by the central controller system that identifies at least one UV light source in which the power, direction, and duration of illumination is commanded. In one embodiment, the light controller operates the functions of the power supply to the UV light and commands a motor to index to the appropriate direction to cause directed illumination of a low flying animal. In one embodiment, the central controller continues to monitor and respond to low flying animal objects until the sensors indicate that the airspace is without threats.

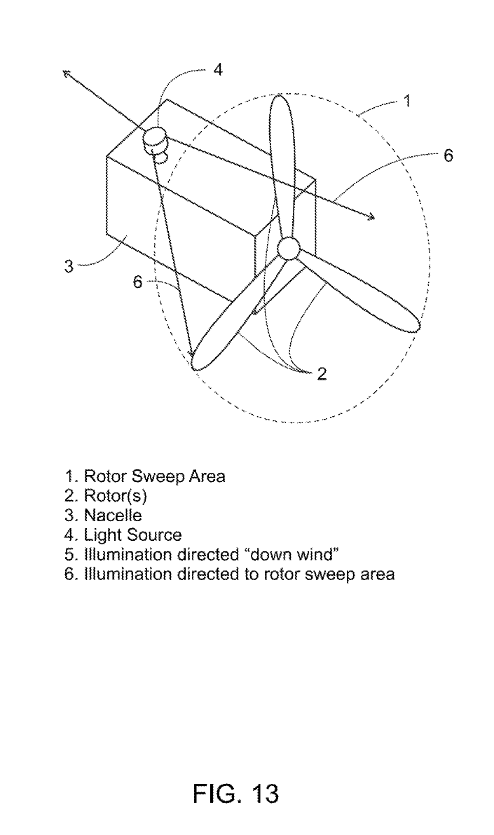

FIG. 13 is an illustration, of one embodiment of a utility size wind turbine with a light illumination system of the present invention. The rotor sweep area 1 is the airspace in which the wind turbine rotors 2 intersect, the flight path of animals which often times results in mortality. The light source 4 is located on the nacelle 3 of the wind turbine, in one embodiment for the present invention, a portion of the lights are directed downwind, from the rotor sweep area and a portion of the lights are directed to maximize the illumination of the rotor sweep area.

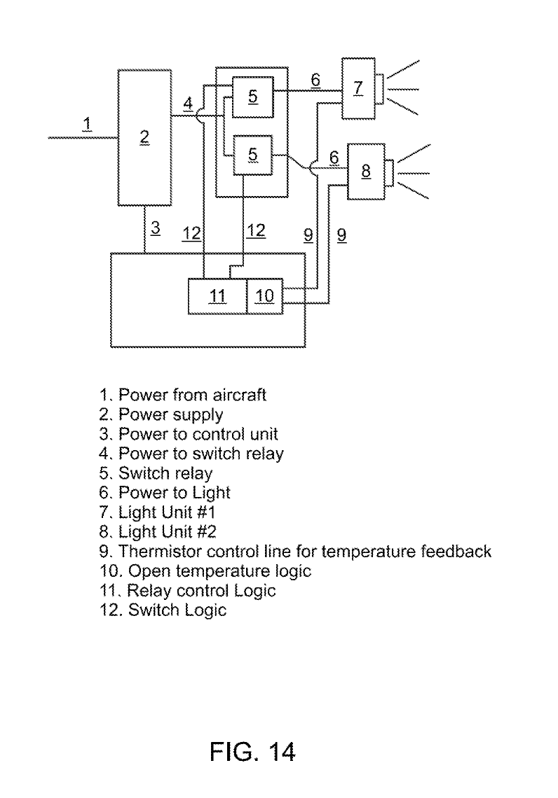

FIG. 14 is an illustration of one embodiment of the present invention. There, the components of an integrated aircraft: landing light with UV light sources of the present invention configured to conform to industry standard land light dimensions and power requirements is shown. The industry standard land light characteristics are identified by their PAR (parabolic aluminized reflector) number. The nominal reflector diameter and standard voltage and power of one embodiment of the invention are shown in Table 1.

TABLE 1

| | Nominal diameter | | |
|---|---|---|---|
| | (inches) | Nominal Voltage | Nominal Wattage |
| PAR 64 | 8 | 28 | 500 |
| PAR 56 | 7 | 28 | 500 |
| PAR 46 | 6 | 12-28 | 450 |
| PAR 38 | 4¾ | 12-28 | 150 |
| PAR 36 | 4½ | 12-28 | 150 |

The nominal power from the aircraft is configured to supply the appropriate power to the controller, the switch relays, and the light sources. In one embodiment of the present invention, the light source consists of a light unit or plurality of light units that illuminates ultraviolet, light, and a light unit or plurality of light units that emits visible light. In one embodiment of the present invention, the light units have a thermistor that provides electrical feedback of the operating temperature of the light unit to the controller. Two primary functions of the controller comprise an over-temperature control circuit and logic, and a switch relay control logic for each relay. The switch relay logic alternates power between each of the light units. In one embodiment of the present invention, in the event that an over-temperature event occurs, the over-temperature control circuit and logic modifies the sequence of power between each of the light units to reduce the duty cycle load thereby producing a reduction of waste heat generated by the apparatus and protects the light sources from damage.

In one embodiment of the present invention, the sensor has an average output power of about 1 kW, about 2 kW about 3 kW, about 4 kW, about 5 kW, about 6 kW, or about 7 kW. In one embodiment of the present invention, the sensor has an average output power of about 8 kW, about 9 kW, about 10 kW, about 11 kW, about 12 kW, about 13 kW, or about 14 kW. In one embodiment of the present invention, the sensor has an average output power of about 15 kW, about 16 kW, about 17 kW, about 18 kW, about 19 kW, about 20 kW, or about 21 kW. In one embodiment of the present: invention, the sensor has an average output power of about 22 kW, about 23 kW, about 24 kW, about 25 kW about 26 kW, about 27 kW, or about 28 kW.

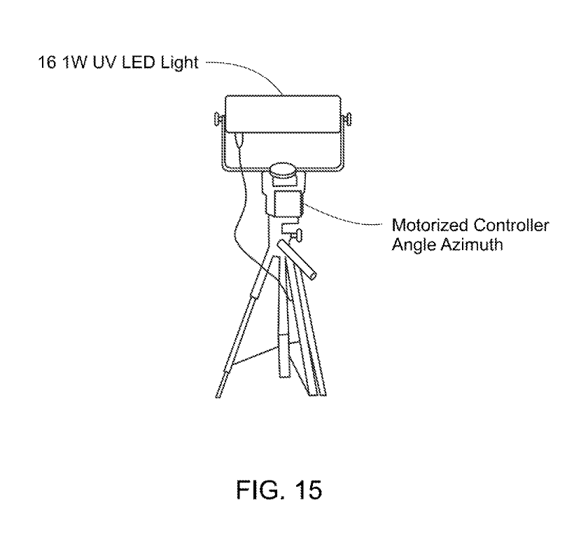

FIG. 15 shows one embodiment of the present invention using a black light source manufactured by American DJ. The UV LED BAR 16-RS Lighting Black Light Wash DMX Light Lamp had a field of illumination equal to 10 degrees (V) and 40 degrees (H). The LED optical lens could also be replaced with LED collimating lens to generate a 5.7 degree field of illumination. The motorized controller was a common Professional Photographer pan/tilt controller that mounted onto a tripod. Remote controlled pan/tilt systems are commonly utilized with security cameras, disc jockey stage lighting, satellite tracking, and military tracking applications, etc. controller commands and available hardware utilized DMX, G-code, or similar commands.

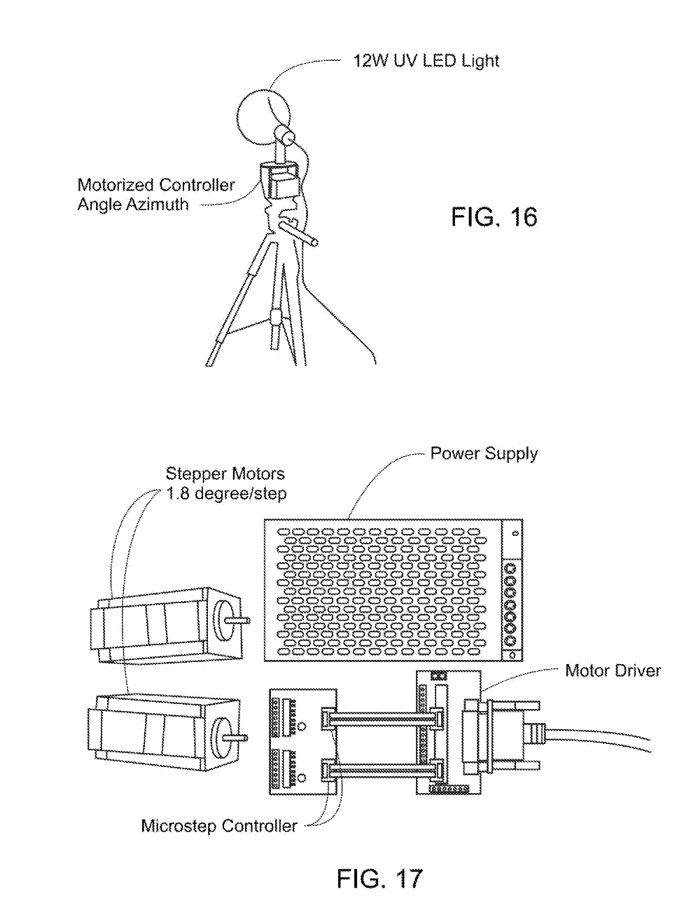

FIG. 16 shows one embodiment of the present invention using a UV source with a 12-Watt UV LED Light Bulb with a standard screw-in base. The light source used 110 V AC up to 240 V AC at 395 nm UV wavelength. The system provided an all-aluminum heat sink body to dissipate heat with a 45-degree spot lens. Additional focusing lens were added to generate a 15 degree field of illumination. FIG. 17 shows one embodiment of the present Invention using an off-the-shelf kit for multiple axis control by Prohotix. The precise, fast, motion of multiple axis is commonly utilized in CNC applications. EMC2 (GNU license—free) supported G-codes commands were used to drive the motors.

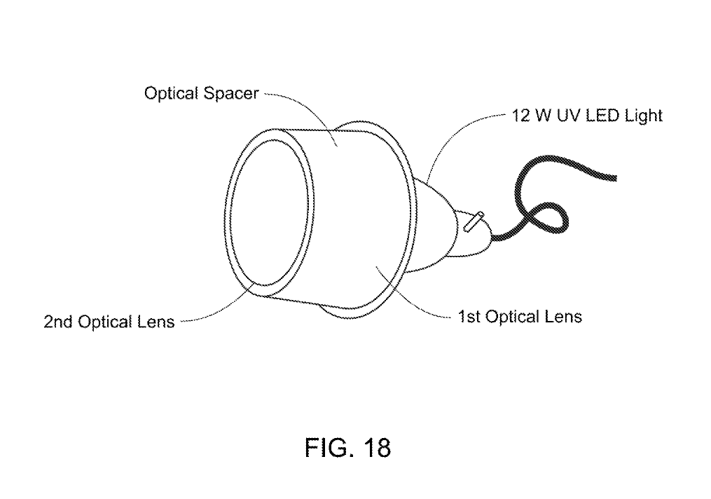

FIG. 18 shows one embodiment of the present invention where the UV source was a 12-Watt VJV LED Light Bulb with a standard screw-in base. The light source used 110 V AG up to 240 V AC at 395 nm UV wavelength. The first and second optical, lenses were purchased from Edmund Optics (PCX 100 mm×400 FL) and Rolyn Optics Company (Bi Convex 11.0245) and were mounted in a plastic pipe.

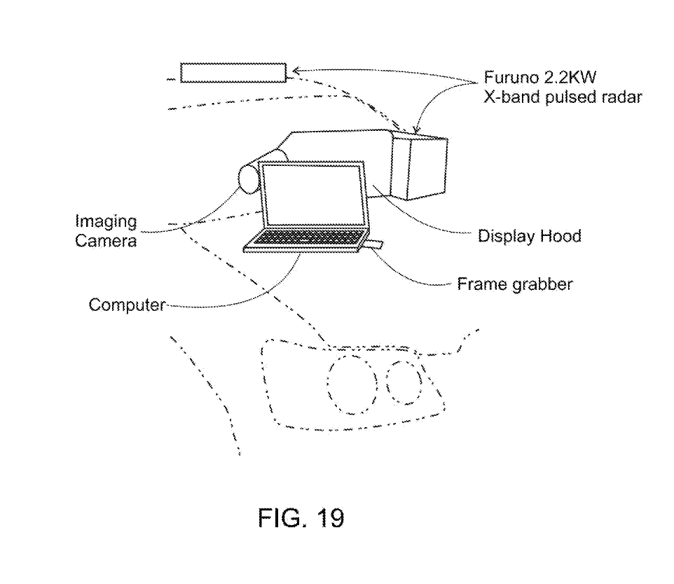

FIG. 19 shows an embodiment of the present invention. There, the sensor was a radar unit. The radar unit was a stock 4 KW Furuno marine radar with a Model 1832 monocolor display. The display hood shielded the display from receiving outside illumination. The Imperex B/W camera with security lens captured the Furuno displayed image. The frame grabber collected the images from the imperex camera and converted them to a digital stream which, was directly interlaced to an image processing program or stored on a hard drive.

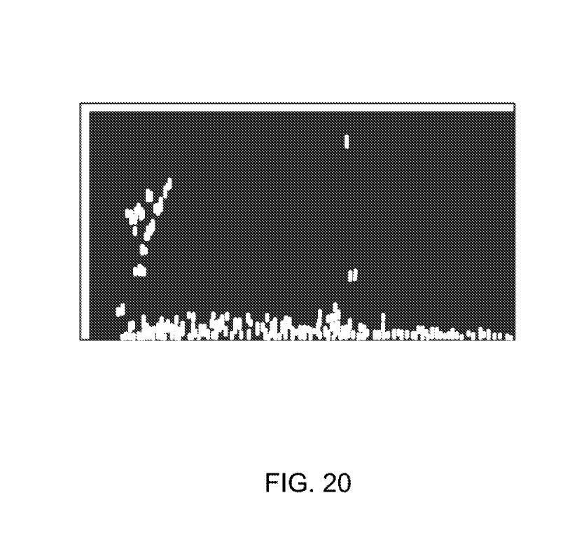

FIG. 20 shows results from one embodiment of the present: invention using an unmodified 12 KW Furuno marine radar with monocolor display. The unit successfully identified and tracked seagulls at a 3 to 3.5 mile range. A separate test was performed using a modified 12 KW Furuno marine radar irons which I and Q data was collected. Custom algorithms were also used to track seagulls which were able to remove sea “clutter” at the 2 to 3 mile range. There, the radar was located on a 60 foot high bluff overlooking open ocean.

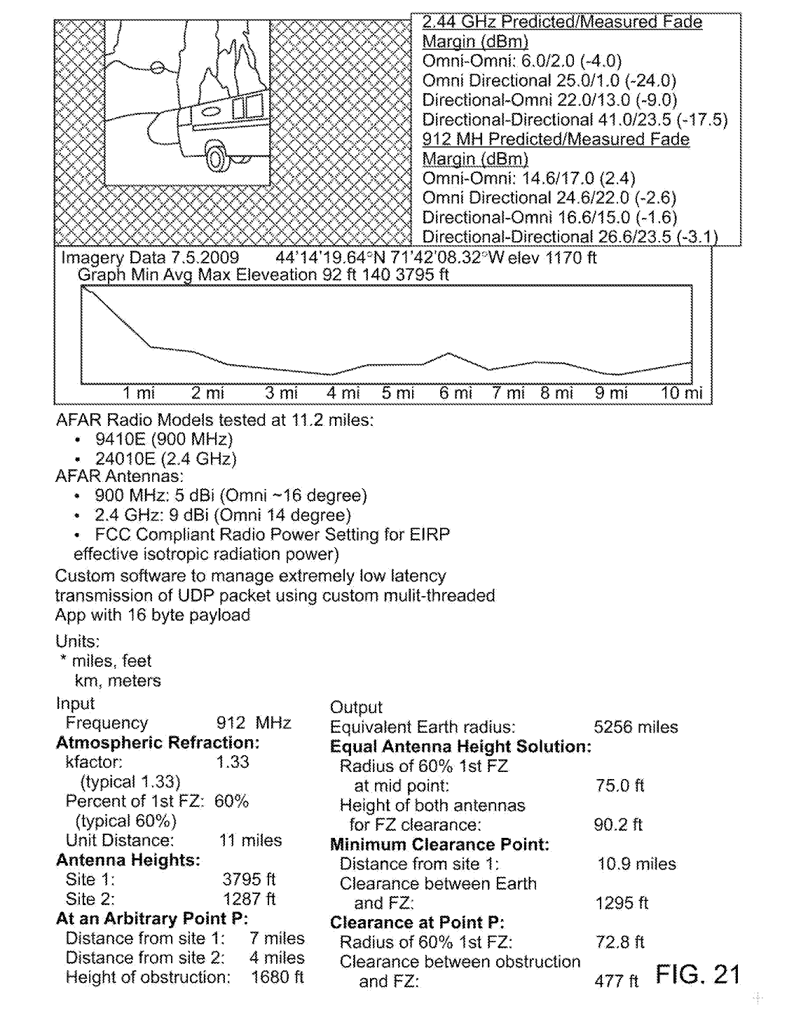

FIG. 21 shows results of field testing. There, AFAR Radio Models were tested at 11.2 miles. Custom software was used to manage extremely low latency transmission of UDP packet using a custom multi-threaded App with 16 byte payload.

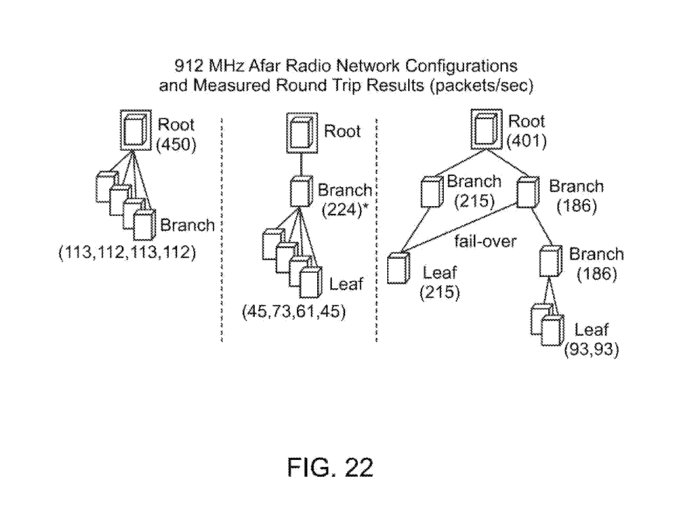

FIG. 22 shows one embodiment of the present invention with 91.2 MHz Afar Radio Network Configurations used to Measure Round Trip Results (packets/see). There, an AFAR Radio Model 9410E (900 MHz) TCP network capacity test utilized AFAR 5 dBi (Omni −16 degree) and a single 15 dBi (Directional −10 degree) antenna. 20 dBm attenuators were used to prevent over modulation of the signal due to close proximity of the radios used throughout this test. The numbers reported are for managed UDP round trip packets/sec across the wireless network with low latency.

In one embodiment of the present invention, the avoidance response is an involuntary response resulting from a brightness contrast to the apparent background brightness from the perspective of the animal is about a 10:1 ratio. In one embodiment, the ratio is about 20:1, about 30:1, about 40:1 about 50:1, about 60:1, about 70:1, about 80:1, about 90:1, about or 100:1. In one embodiment, the ratio is about 110:1, about 120:1, about 130:1, about 140:1, about 150:1, about 160:1, about 170:1, about 180:1, about 190:1, about or 200:1. In one embodiment, the ratio is about 210:1, about 220:1, about 230:1, about 240:1, about 250:1, about 260:1, about 270:1, about 280:1, about 290:1, about or 300:1. In one embodiment, the ratio is about 310:1, about: 320:1, about 330:1, about 340:1, about 350:1, about 360:1, about 370:1, about 380:1, about 390:1, about or 400:1. In one embodiment, the ratio is about 410:1, about 420:1, about: 430:1, about 440:1, about 450:1, about 460:1, about 470:1, about 480:1, about 490:1, about or 500:1. In one embodiment, the ratio is about 510:1, about 520:1, about 530:1, about 540:1, about 550:1, about 560:1, about 570:1, about 580:1, about 590:1, about or 600:1. In one embodiment, the ratio is about 610:1, about 620:1, about 630:1, about: 640:1, about 650:1, about 660:1, about 670:1, about 680:1, about 690:1, about or 700:1. In one embodiment, the ratio is about 710:1, about 720:1, about 730:1, about 740:1, about 750:1, about 760:1, about 770:1, about 780:1, about 790:1, about or 800:1. In one embodiment, the ratio is about 8.10:1, about 820:1, about 830:1, about 840:1, about 850:1, about 860:1, about 870:1, about 880:1, about 890:1, about or 900:1. In one embodiment, the ratio is about 1000:1, about 2000:1, about 3000:1, about 4000:1, about 5000:1, about 6000:1, about 7000:1, about 8000:1, about 9000:1, about or 10000:1.

In one embodiment of the present invention, the avoidance response is an involuntary response resulting from an illumination intensity of less than about 0.6 W/cm².

In certain embodiments, the avoidance response is an involuntary response resulting from an induced oscillating eye pupil dilation resulting from a changing illumination state between ‘on’ and ‘off’ conditions with a time interval from about 100 milliseconds to about 5 seconds. In one embodiment, the time interval is about 0.001 s, about 0.002 s, about 0.003 s, about 0.004 s, about 0.005 s, about 0.006 s, about 0.007, about 0.008 s, about 0.009 s, or about 0.01 s. In one embodiment, the time interval is about. 0.02 s, about 0.03 s, about 0.04 s, about 0.05 s, about 0.06 s, about 0.07 s, about 0.08 s, about 0.09 s, or about 0.1 s. In one embodiment, the time interval is about 0.2 s, about 0.3 s, about 0.4 s, about 0.5 s, about 0.6 s, about 0.7 s, about 0.8 s, about 0.9 s, or about 1 s. In one embodiment, the time interval is about 2 s, about 3 s, about 4 s, about 5 s, about 6 s, about 7 s, about 9 s, about 9 s, or about 10 s.

In certain, embodiments, the spatial separation of the plurality of illumination sources is an angular amount from about 1 degree to about 15 degrees. In one embodiment, the spatial separation of the plurality of illumination sources is an angular amount of about 1 degree, about 2 degrees, about 3 degrees, about 4 degrees, about 5 degrees, about 6 degrees, about 7 degrees, about 8 degrees, about 9 degrees, or about 10 degrees. In one embodiment, the spatial separation of the plurality of illumination sources is an angular amount of about 11 degrees, about 12 degrees, about 13 degrees, about 14 degrees, about 15 degrees, about 16 degrees, about 17 degrees, about 18 degrees, about 19 degrees, or about 20 degrees. In one embodiment, the spatial separation of the plurality of illumination sources is an angular amount of about 21 degrees, about 22 degrees, about 23 degrees, about 24 degrees, about 25 degrees, about 26 degrees, about 27 degrees, about 28 degrees, about 29 degrees, or about 30 degrees. In one embodiment, the spatial separation of the plurality of illumination sources is an angular amount of about 31 degrees, about 32 degrees, about 33 degrees, about 34 degrees, about 35 degrees, about 36 degrees, about 37 degrees, about 38 degrees, about 39 degrees, or about 40 degrees. In one embodiment, the spatial separation of the plurality of illumination sources is an angular amount of about 41 degrees, about 42 degrees, about 43 degrees, about 44 degrees, or about 45 degrees.

In certain embodiments, the response communicated by the central controller to the plurality of illumination sources is configured to modify the intensity, direction, sequence, duration of illumination, and any combination thereof.

In certain embodiments of the present invention band-pass filters are used to narrow the range of wavelengths emitted by the illumination source. In certain embodiments of the present invention, UV pass filters may be used to control the range of wavelengths emitted by the illumination source.

In certain embodiments, the plurality of illumination sources are light emitting diodes having a peak emission wavelength from about 280 nm to about 400 nm. In one embodiment, the light emitting, diodes have a peak emission wavelength from about 320 nm to about 400 nm. In one embodiment, the light emitting diodes have a peak emission wavelength from about 340 nm to about 400 nm. In one embodiment, the light emitting diodes have a peak emission wavelength from about 350 nm to about 400 nm. In one embodiment, the light emitting diodes have a peak emission wavelength of about 280 nm, about 290 nm, about 300 nm, about 310 nm, about 320 nm, about 330 nm, about 340 nm, or about 350 nm. In one embodiment, the light emitting diodes have a peak emission wavelength of about 360 nm, about 370 nm, about 380 nm, about 390 nm, or about 400 nm.

In certain embodiments, the sensor is configured to differentiate between objects such as low flying animals and larger, faster moving objects that are within the protected area. In certain embodiments, the sensor is configured to utilize signal processing of multiple samples over time to differentiate objects with a low signal to noise ratio that exhibit persistence of motion characteristic of animals of interest from that of general background signal noise within the protected area.

In certain embodiments, the central controller communicates with the sensors and illumination sources using data packets and TCP protocols over a wireless network. In certain embodiments, the central controller determines the appropriate response to the moving objects of interest using rules of escalating responses to issue illumination commands consisting of range, bearing azimuth, power level of emission, duration of emission, and coordinated flashing sequence to each illumination source to be directed at the moving object of interest.

While the principles of the invention have been, described herein, it is to be understood by those skilled in the art that this description is made only by way of example and not as a limitation as to the scope of the invention. Other embodiments are contemplated within the scope of the present invention in addition to the exemplary embodiments shown and described herein. Modifications and substitutions by one of ordinary skill in the art are considered to be within the scope of the present invention.

What is claimed:

1. A method for detecting the presence of one or more animals, comprising:
providing a single radar unit, wherein the radar unit comprises a transmitter and a receiver and the single radar unit transmits microwave or radio wave radiation:
collecting a series of data samples from narrowly focused radar pulses, wherein the narrowly focused radar pulses vary by an angle of separation that is equal to or less than half of the angle of the beam angle of propagation thereby producing a series of overlapping scans; and
determining the range, distance, and altitude of one or more animals.

2. The method, for detecting the presence of one or more animals of claim 1, wherein the transmitter utilizes an X-band, pulsed radar beam of about 2 kW average power and the receiver is a parabolic dish antenna.

3. The method for detecting the presence of one or m ore animals of claim 2, wherein the pulsed radar beams occur at a pulse repetition frequency.

4. The method for detecting the presence of one or more animals of claim 3, wherein the pulse repetition frequency is at least 1 KHz.

5. The method for detecting the presence of one or more animals of claim 1, further comprising the step of providing a pan/tilt controlled motorized base platform upon which the single radar unit: is mounted and controlled in azimuth and elevation angle.

6. The method for detecting the presence of one or more animals of claim 1, wherein the narrowly focused radar pulses vary by a vertical angle of separation that is equal to or less than 5% of the angle of the beam angle of propagation.

7. The method for detecting the presence of one or more animals of claim 1, wherein the narrowly focused radar pulses vary by a horizontal angle of separation that is equal to or less than 33% of the angle of the beam angle of propagation.

8. The method for detecting the presence of one or more animals of claim 5, wherein the pan/tilt controlled motorized base platform is configured to accurately encode the position associated with each unique radar pulse.

9. The method for detecting the presence of one or more animals of claim 5, further comprising the step of providing an external A/D signal processing apparatus to analyze sequentially consecutive series of radar data into a 3D digital image.

10. The method for detecting the presence of one or more animals of claim 9, further comprising the step of providing an external A/D signal conversion apparatus, wherein the return analog signal of each radar pulse is sampled and digitized by the external A/D signal.

11. The method for detecting the presence of one or more animals of claim 10, wherein the A/D signal conversion apparatus is configured to process data, at a rate of at least 1 MHz and a sample depth of at least 10 bits.

12. The method for detecting the presence of one or more animals of claim 10, further comprising the steps of determining the range to the object by means of signal-time measurements, determining the bearing by means of transmission pulses in the respective azimuth, and determining the altitude of the object by means of successive signal-time measurements as the transmission pulses varies in the respective elevation direction using the A/D signal conversion apparatus.

13. The method for detecting the presence of one or more animals of claim 9, wherein the external A/D signal processing apparatus is configured to process signal strength, rate of velocity, variation of a single point in relation to adjacent points in three dimensional airspace, and the variation from previously sampled points in the same three dimensional point in airspace.

14. The method for detecting the presence of one or more animals of claim 5, wherein the pan/tilt controlled motorized base platform motion is configured to scan the pulsed radar beams propagated by the parabolic, dish antenna faster in the vertical direction as compared to the horizontal direction.

15. The method for detecting the presence of one or more animals of claim 9, wherein the external A/D signal, processing apparatus incorporates known external conditions, such as wind direction and speed, and known locations of signal returns.

16. The method for detecting the presence of one or m ore animals of claim 10, further comprising the steps of providing an external controller unit that interlaces and controls the pan/tilt controlled base platform, the pulse repetition frequency, the A/D signal conversion apparatus, and the A/D signal processing apparatus.

17. The method for detecting the presence of one or more animals of claim 9, wherein the external A/D signal processing apparatus compares the location in three-dimensional space of an animal to a particular set of conditions to determine whether a notification should be sent.

18. The method for detecting the presence of one or more animals of claim 17, wherein the notification comprises logging, sending a warning, or the like.

19. A method for producing an avoidance response in an animal, comprising;
providing a plurality of illumination sources wherein the illumination source is a light emitting diode having a peak emission wavelength from about 320 nanometers to about 400 nanometers;
providing a plurality of sensors; and
providing a central controller, wherein the central controller is configured to receive data from the plurality of sensors, combine the data received from the plurality of sensors to create a complete situational awareness, and communicate a response to the plurality of illumination sources thereby producing an avoidance response in an animal.

20. The method for producing an avoidance response in an animal of claim 19, wherein the illumination source has a peak emission wavelength from about 355 nanometers to about 390 nanometers.

21. The method for producing an avoidance response in an animal of claim 19, wherein the sensor comprises radar.

22. The method for producing an avoidance response in an animal of claim 21, further comprising collecting a series of data samples from narrowly focused radar pulses, wherein the narrowly focused radar pulses vary by an angle of separation that is equal to or less than half of the angle of the beam angle of propagation thereby producing a series of overlapping scans; and.

23. The method for producing an avoidance response in an animal of claim 22, wherein the situational awareness comprises the range, distance, and altitude of one or more animals.

24. The method for producing an avoidance response in an animal of claim 19, wherein the animal is a flying animal.

25. The method for producing an avoidance response in an animal of claim 19, wherein the animal is a swimming animal.

26. The method for producing an avoidance response in an animal of claim 19, wherein the animal is a diving animal.

27. The method for producing an avoidance response in an animal of claim 19, wherein the avoidance response is an involuntary response resulting from a brightness contrast to the apparent background brightness from the perspective of the animal of at least a 10:1 ratio and the illumination intensity is less than 0.6 W/cm².

28. The method for producing an avoidance response in an animal of claim 19, wherein the avoidance response is an involuntary response resulting from an induced oscillating eye pupil dilation resulting from a changing illumination state between ‘on’ and ‘off’ conditions with a time interval from about 100 milliseconds to about 5 seconds.

29. The method for producing an avoidance response in an animal of claim 19, wherein the spatial separation of the plurality of illumination sources is an angular amount from about 1 degree to about 15 degrees.

30. The method for producing an avoidance response in an animal of claim 19, wherein the response communicated by the central controller to the plurality of illumination sources is configured to modify the intensity, direction, sequence, duration of illumination, and any combination thereof.

31. The method for producing an avoidance response in an animal of claim 19, wherein the sensor is configured to differentiate between objects such as low flying animals and larger, faster moving objects that are within the protected area.

32. The method for producing an avoidance response in an animal of claim 19, wherein the sensor is configured to utilize signal processing of multiple samples over time to differentiate objects with a low signal to noise ratio that exhibit persistence of motion characteristic of animals of interest from general background signal noise within the protected area.

33. The method for producing an avoidance response in an animal of claim 19, wherein the central controller communicates with the sensors and illumination sources using data packets and TCP protocols over a wireless network.

34. The method for producing an avoidance response in an animal of claim 19, wherein the central controller determines the appropriate response to the moving objects of interest using rules of escalating responses to issue illumination commands consisting of range, bearing azimuth, power level of emission, duration of emission, and coordinated flashing sequence to each illumination source to be directed at the moving object of interest.

35. A system for producing an avoidance response in an animal, comprising;
a plurality of illumination sources wherein the illumination source is a light emitting diode;
a plurality of sensors; and
a central controller configured to receive data from the plurality of sensors, combine the data received front the plurality of sensors to create a complete situational awareness, and communicate a response to the plurality of illumination sources thereby producing an avoidance response in an animal.

36. The system for producing an avoidance response in an animal of claim 35, wherein the plurality of illumination sources is configured to illuminate the rotor sweep area and surrounding airspace of a wind turbine with light having a peak emission wavelength from about 370 nanometers to about 400 nanometers.

37. The system for producing an avoidance response in an animal of claim 35, further comprising a power supply, power relay, controller electronics, and thermistors.

38. The system for producing an avoidance response in an animal of claim 35, wherein the plurality of illumination sources conforms to the standard aircraft industry landing light configuration for dimensions and power specifications and has a peak emission wavelength from about 355 nanometers to about 400 nanometers.

39. The system, for producing an avoidance response in an animal of claim 38, wherein the plurality of illumination sources is directed to the airspace directly in front of the aircraft which, overlaps the airspace illuminated by the aircraft's traditional landing lights.

40. The system for producing an avoidance response in an animal of claim 38, further comprising a plurality of illumination sources that are configured to emit light having a peak emission wavelength from about 400 nanometers to about 700 nanometers.

41. The system for producing an avoidance response in an animal of claim 35, further comprising a power supply, electronic controller, and power relay switch.

42. The system for producing an avoidance response in an animal of claim 35, wherein the illumination sources are configured to alternate between ‘on’ and ‘off’ conditions with a time interval from about 100 milliseconds to about 1.5 seconds.

43. The system for producing an avoidance response in an animal of claim 37, wherein the illumination sources are configured to alternate between ‘on’ and ‘off’ conditions in response to an over temperature condition.
